(19) United States
(12) Patent Application Publication
(10) Pub. No.: US 2026/0296370 A1
(43) Pub. Date: Oct. 1, 2026

(54) DEVICES, SYSTEMS, AND METHODS FOR AUTHORIZING ACCESS TO A PROTECTED RESOURCE

(71) Applicant: Cypress Semiconductor Corporation, San Jose, CA (US)

(72) Inventors: Vivekanandh ELANGOVAN, Canton, MI (US); Ajinder Pal Singh, Allen, TX (US); Victor Zhodzishsky, Potomac, MD (US)

(73) Assignee: Cypress Semiconductor Corporation, San Jose, CA (US)

(21) Appl. No.: 19/345,750

(22) Filed: Sep. 30, 2025

Related U.S. Application Data
(60) Provisional application No. 63/781,865, filed on Apr. 1, 2025.

(51) Int. Cl. B60R 25/24; B60R 25/04

(52) U.S. Cl. CPC B60R 25/245; B60R 25/04; B60R 2325/101

(57) ABSTRACT

Devices, systems, and methods select a first wireless device based on one or more selection criteria. The selected first wireless device is located within a predefined space using radio frequency (RF) signals associated with a first communication protocol. While locating the first wireless device, a plurality of second wireless devices are also located within the predefined space using RF signals associated with a second communication protocol. Access to a first protected resource is authorized based on the location of the first wireless device.

### RELATED APPLICATIONS

This application claims the priority benefit of U.S. Provisional Application No. 63/781,865 filed Apr. 1, 2025, which is incorporated herein by reference in its entirety.

### TECHNICAL FIELD

The subject matter relates to the fields of access authorization and wireless communications. More specifically, but not by way of limitation, the subject matter discloses techniques for authorizing access to protected resources, based on the location of wireless devices.

### BACKGROUND

With the proliferation of the Internet of Things (IoT), many applications require a procedure for determining whether to authorize wireless devices to access protected resources. Such procedures may include determining the locations of wireless devices, which consumes time and energy. For example, some conventional vehicle access systems use Ultra-wideband (UWB) localization to serially locate all wireless devices (such as key fobs and phones) proximate to a vehicle cabin before authorizing access to some vehicle functions.

### BRIEF DESCRIPTION OF THE DRAWINGS

Some embodiments are illustrated by way of example and not limitation in the figures of the accompanying drawings in which:

FIG. 1 is a schematic diagram illustrating a top view of a vehicle and portions of a vehicle access system, in accordance with embodiments;

FIG. 2 is a block diagram illustrating wireless devices interacting an access system, in accordance with embodiments;

FIG. 3 is a block diagram illustrating Ultra-wideband (UWB) localization, in accordance with embodiments;

FIG. 4 is a block diagram illustrating Bluetooth Low Energy (BLE) localization, in accordance with embodiments;

FIG. 5A is a block diagram illustrating Time of Flight (ToF) data for UWB localization, in accordance with embodiments;

FIG. 5B is a block diagram illustrating Received Signal Strength Indicator (RSSI) data for BLE localization, in accordance with embodiments;

FIG. 5C is a block diagram illustrating Channel Sounding (CS) data for BLE localization, in accordance with embodiments;

FIG. 5D is a block diagram illustrating Angle (AGL) data for BLE localization by, in accordance with embodiments;

FIG. 6 is a timing diagram illustrating timing of UWB localization and UWB localization, in accordance with embodiments;

FIG. 7 is a block diagram illustrating a host processing system, in accordance with embodiments;

FIG. 8 is a block diagram illustrating an anchor device, in accordance with embodiments;

FIG. 9 is a table diagram illustrating a selection criteria, in accordance with embodiments; and

FIG. 10 is a flow diagram illustrating a method of authorizing access to protected resources, in accordance with embodiments.

### DETAILED DESCRIPTION

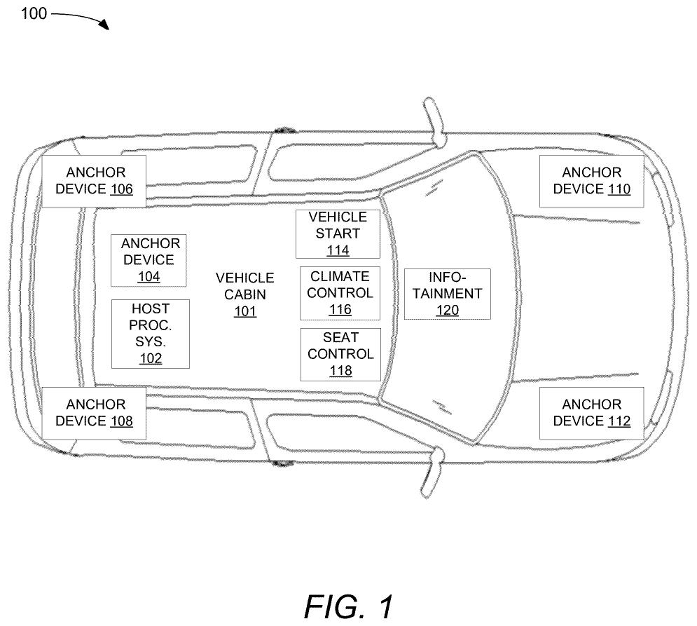

Devices, systems, and methods for authorizing access to a protected resource are described. In the following description, for purposes of explanation, numerous examples and embodiments are set forth to provide a thorough understanding of the claimed subject matter. It will be evident to one skilled in the art that the claimed subject matter may be practiced in other embodiments. Some embodiments are now briefly introduced and then discussed in more detail along with other embodiments beginning with FIG. 1.

Embodiments relate to access systems that determine whether or not to authorize wireless devices such as phones and key fobs to access protected functions, based on the location of the wireless devices. Some embodiments relate to vehicle access systems. A vehicle access system may generally include multiple fixed wireless devices coupled to a vehicle processing system via a wired bus such as a Controller Area Network (CAN) bus. The fixed devices may include a central anchor device and secondary anchor devices, each including UWB and/or Bluetooth Low Energy (BLE) communication logic. A vehicle access system may authorize access in compliance with a standard body such as Connected Car Consortium (CCC), which may require UWB to be used for localization when deciding whether to authorize keyless start because of a level of attack resistance and accuracy UWB can provide. Other vehicle functions may include, for example, keyless entry, various infotainment system functions, climate control, and seat control.

In such vehicle access systems, UWB is conventionally used to localize all detected wireless devices to determine whether access to any vehicle functions should be authorized, not just vehicle start. Numerous wireless devices may need to be localized when there are multiple passengers, especially when each vehicle occupant holds more than one potential wireless key (e.g., watch, phone, key fob, or tablet).

Convention vehicle access systems create authorization latency. In UWB localization, each anchor and each wireless device need to establish a connection with one another and exchange information used for localization processing, where the wireless devices are localized serially, one after another. In addition, under CCC standards, the minimum time allowed by the CCC to localize each wireless device is 96 ms. Therefore, the time to authorize keyless entry is at least 96 ms times the number of wireless devices that need to be localized using UWB. For example, when four potential wireless keys are present, the authorization process takes at least 384 ms. Moreover, using UWB to localize all detected wireless devices when only one wireless device is needed for a particular vehicle function, such as keyless start, can cause the vehicle access system and the wireless devices themselves to consume more power than necessary to authorize a single device with respect to the vehicle function. Embodiments described herein can reduce authorization latency and power consumption associated with authorizing access to vehicle functions.

In embodiments, rather than using UWB to locate all connected wireless devices, one wireless device is selected for UWB localization, and the other wireless devices are located using BLE localization. BLE localization of the other wireless devices can take place concurrently with the UWB localization of the selected wireless device, which can reduce latency (and the time a user needs to wait to access the vehicle function (e.g., keyless start) compared to conventional serial UWB localization of multiple devices. Localizing the other wireless devices using BLE localization can also reduce power consumption compared to conventional UWB localization of multiple devices. Therefore, in embodiments, vehicle functions that require a relatively higher security level (e.g., higher attack resistance) such as keyless start may be authorized based on UWB localization, while vehicle functions that require relatively lower security level (e.g., lower attack resistance) may be authorized based on BLE localization, all while taking less time and consuming less power than conventional authorization techniques.

Accordingly, embodiments described herein select a first wireless device based on one or more selection criteria and then locate the selected first wireless within a predefined space, based on RF signals associated with a first communication protocol. While locating the selected first wireless device, a plurality of second wireless devices are located within the predefined space, based on RF signals associated with a second communication protocol. Embodiments authorize access to a first protected resource based on the location of the first wireless device. By selecting a first wireless device for localization using a first communication protocol and, concurrently, locating a plurality of second wireless devices using a second communication protocol, the overall latency and power consumption associated with the authorization process can be significantly reduced.

By locating a plurality of second wireless devices using a second communication protocol, the overall latency and power consumption associated with the authorization process can be significantly reduced. This is achieved by enabling concurrent localization operations using different protocols, such as UWB for the selected first wireless device and Bluetooth Low Energy (BLE) for the plurality of second wireless devices, thereby allowing for faster and more energy-efficient access authorization compared to conventional systems.

Selecting a first wireless device based on one or more selection criteria provides efficiency in determining which device to prioritize for high-security localization. The selection criterion may include, for example, a history of use of the wireless device, a type of wireless device, access rights associated with the wireless device, or a combination thereof. According to some embodiments, the first wireless device may be selected as the most recently authorized device for keyless entry, the device most frequently used for keyless start, or a device with a higher battery capacity, such as a mobile phone, to conserve power in other devices, such as a key fob.

Locating the selected first wireless device within a predefined space, based on RF signals associated with a first communication protocol, provides accurate determination of the device's position relative to the vehicle. The first communication protocol may include UWB, which offers high accuracy and attack resistance, making it suitable for authorizing access to protected resources such as keyless start. The predefined space may include a vehicle cabin, and the localization may be performed using UWB location data, such as Time of Flight (ToF) data, received from a plurality of anchor devices communicatively coupled with a host processing system.

While locating the selected first wireless device, locating a plurality of second wireless devices within the predefined space, based on RF signals associated with a second communication protocol, provides concurrent determination of the positions of additional devices. The second communication protocol may include BLE, and the localization may be performed using BLE location data, such as Received Signal Strength Indicator (RSSI) data, Channel Sounding (CS) data, Angle of Arrival (AoA) data, or Angle of Departure (AoD) data. According to some embodiments, BLE localization may be supported by anchor devices eavesdropping on communications between the wireless devices and a central device and forwarding the relevant location data to the host processing system for localization. The concurrent use of BLE for the plurality of second wireless devices reduces the overall time and power required for localization, as BLE localization can be performed in parallel with UWB localization.

Authorizing access to a first protected resource based on the location of the first wireless device provides secure and efficient control over vehicle functions. The first protected resource may include a keyless start function, and the authorization may be based on the determination that the selected first wireless device is located within the vehicle cabin. According to some embodiments, access to additional vehicle functions, such as infotainment, seat adjustment, or climate control, may be authorized based on the locations of the plurality of second wireless devices.

In this description, aspects of the claimed subject matter are described with respect to a vehicle access system. It should be apparent to those having ordinary skill in the art reading the specification and drawings that inventive aspects are applicable in other applications needing access control, such as in the smart home, hospital settings, industrial settings, office settings, or other applications in which access to protected resources is controlled.

The detailed description section includes references to the accompanying drawings, which form a part of the detailed description. The drawings show illustrations in accordance with embodiments. These embodiments, which are also referred to herein as “examples,” are described in enough detail to enable those skilled in the art to practice embodiments of the claimed subject matter. The embodiments may be combined, other embodiments may be utilized, or structural, logical, and electrical changes may be made without departing from the scope of what is claimed. The following detailed description is, therefore, not to be taken in a limiting sense, and the scope is defined by the appended claims and their equivalents.

FIG. 1 is a schematic diagram illustrating a top view of a vehicle 100 and portions of a vehicle access system, in accordance with embodiments. The vehicle 100 may include, without limitation, an automobile, a truck, a van, a bus, or any other form of transport. The vehicle cabin 101 is a space of the vehicle 100 in which occupants (not shown) and wireless devices (not shown) may be. The vehicle cabin may include, without limitation, a passenger compartment, a driver compartment, and a cargo area that is or is not accessible from within the vehicle.

The host processing system 102 is configured to perform various operations to select mobile devices for localization based on selection criteria, locate mobile devices within the vehicle cabin 101, and authorize access (e.g., location based) to vehicle functions such as vehicle start 114, climate control 116, seat control 118, and infotainment 120. In various embodiments, the host processing system 102 may be implemented, for example, as a microcontroller unit (MCU), a system-on-chip (SoC), or a general-purpose processor.

Anchor devices 104, 106, 108, 110, and 112 are to wirelessly communicate with wireless devices and generate location data associated with the wireless devices to be used (e.g., by the host processing system 102) for wireless device localization. In some embodiments, the one or more of the anchor devices 104, 106, 108, 110, 112 may provide one or more of the various operations described above with respect to the host processing system 102. The localization data and/or localization techniques used by the anchor devices 104, 106, 108, 110, 112 and/or the host processing system 102 may include other radio frequency-based or sensor-based localization methods. The anchor devices 104, 106, 108, 110, 112 may be capable of communicating via one or more communication protocols, including for example and not limitation, UWB, Wi-Fi, BLE, and/or Zigbee. The anchor devices 104, 106, 108, 110, 112 may be implemented as dedicated UWB/BLE modules, integrated wireless transceivers, or other suitable hardware.

Vehicle start 114 is configured to control the starting of the vehicle 100. Climate control 116 is configured to control the climate within the vehicle cabin 101. Seat control 118 is configured to control the adjustment of seats within the vehicle cabin 101. Infotainment 120 is configured to control entertainment and information systems within the vehicle cabin 101. According to some embodiments, the vehicle functions may include additional or alternative functions, including without limitation, window control, lighting control, or door locking.

The arrangement of the host processing system 102 and the anchor devices 104, 106, 108, 110, 112 throughout the vehicle 100 enables concurrent localization of a selected first wireless device using a first communication protocol and a plurality of second wireless devices using a second communication protocol, thereby reducing overall latency and power consumption for vehicle function authorization compared to conventional systems that localize all devices serially using a single protocol. According to alternative embodiments (not shown), the number and arrangement of anchor devices about the body of the vehicle 100, within or outside of the vehicle cabin 101, may vary depending on the size and configuration of the vehicle 100. In addition, the anchor devices 104, 106, 108, 110, 112 may be arranged in a spatial configuration suitable for protocol-based localizations such as UWB localization and BLE localization wireless devices.

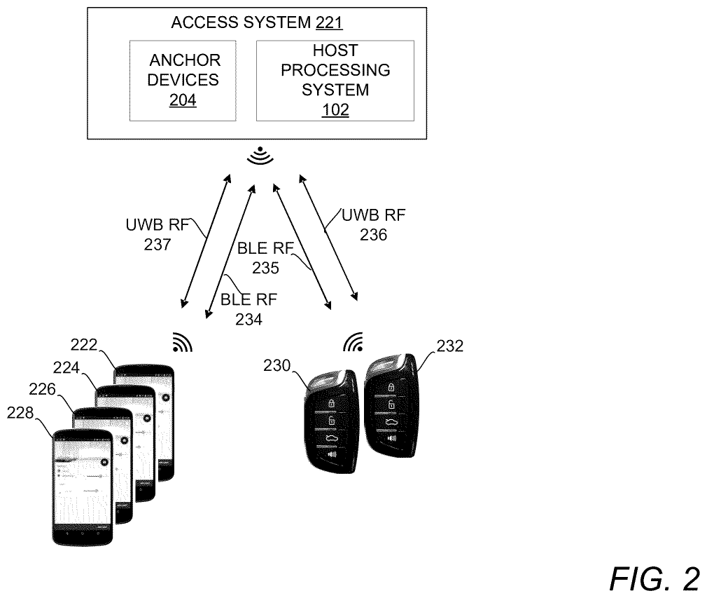

FIG. 2 is a block diagram illustrating wireless devices 222, 224, 226, 228, 230, 232 interacting with an access system 221, in accordance with embodiments. More specifically, FIG. 2 shows an interconnection of a host processing system 102, anchor devices 204, and a plurality of wireless devices 222, 224, 226, 228, 230, 232, as well as the radio frequency (RF) communication links between these components.

The access system 221 includes a host processing system 102 communicatively coupled with anchor devices 204. In some embodiments, the access system 221 may be part of the vehicle 100 of FIG. 1, where the anchor devices 204 include host processing system 102 and the anchor devices 104, 106, 108, 110, 112 described with respect to FIG. 1.

The wireless devices 222, 224, 226, 228, 230, 232 each include a wireless communication interface compatible with at least one of the UWB protocol and the BLE protocol. In the depicted embodiment, the wireless devices 222, 224, 226, 228 include smartphones, each comprising a graphical user interface, a display, and a rechargeable battery. The wireless devices 230, 232 include key fobs, each comprising a housing, a plurality of user interface buttons, and a battery.

The anchor devices 204 are configured to establish UWB RF links 236, 237 with at least one of the wireless devices 222, 224, 226, 228, 230, 232. The anchor devices 204 are further configured to establish BLE RF links 234, 235 with at least one of the wireless devices 222, 224, 226, 228, 230, 232. As will described, the anchor devices 104 may include a plurality of anchor devices, each configured to provide a portion of UWB location data and a portion of BLE location data to the host processing system 102.

The host processing system 102 may be configured to select a first wireless device 228 from among the plurality of wireless devices 222, 224, 226, 228, 230, 232 based on one or more selection criteria. The host processing system 102 may be further configured to localize, using UWB location data, the selected first wireless device 228 within a predefined space, such as the vehicle cabin 101 of FIG. 1. The localization of the second wireless devices 222, 224, 226, 230, 232 may include using BLE location data.

The host processing system 102 may be further configured to concurrently localize a plurality of second wireless devices 222, 224, 226, 230, 232 within the predefined space based on RF signals associated with a second communication protocol, such as the BLE protocol. In embodiments, the localization of the plurality of second wireless devices 222, 224, 226, 230, 232 is completed no later than the localization of the selected first wireless device 228.

The host processing system 102 is configured to authorize access to a first protected resource, such as a vehicle function, based on the location of the first wireless device 228 as determined by the UWB localization. The host processing system 102 may further authorize access to one or more other functions, such as infotainment, seat adjustment, or climate control, based on the location of one or more of the second wireless devices 222, 224, 226, 230, 232 as determined by the BLE localization.

The inventors have realized that by selectively localizing a first wireless device 228 using UWB and concurrently localizing other wireless devices 222, 224, 226, 230, 232 using BLE, the vehicle access system 221 provides reduced latency and power consumption for vehicle access authorization compared to conventional systems that localize all devices serially using a single protocol.

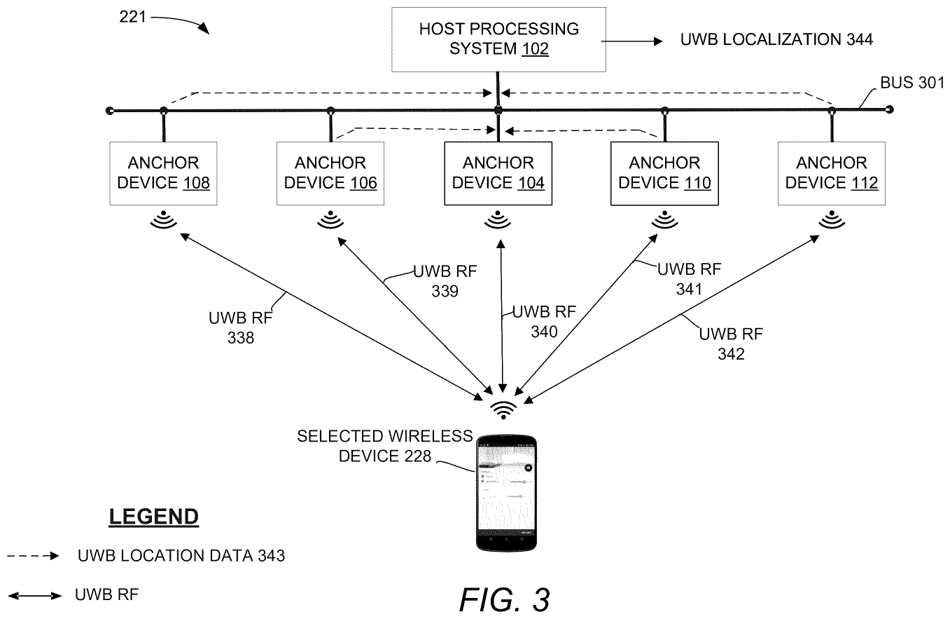

FIG. 3 is a block diagram illustrating Ultra-wideband (UWB) localization, in accordance with embodiments. The access system 221 is shown to include the host processing system 102, the plurality of anchor devices 104, 106, 108, 110, 112, a bus 301, and the selected wireless device 228.

The host processing system 102 is communicatively coupled to each of the anchor devices 104, 106, 108, 110, 112 via the bus 301. The anchor devices 104, 106, 108, 110, 112 are arranged to wirelessly communicate with the selected wireless device 228 via UWB RF signals 338, 339, 340, 341, 342. The anchor devices 104, 106, 108, 110, 112 are further configured to provide UWB location data 343 to the host processing system 102 via the bus 301. The host processing system 102 is configured to perform UWB localization 344 based on the UWB location data 343. As previously described, the host processing system 102 is configured to select the selected wireless device 228 out of a plurality of wireless devices, perform localization to determine that the selected wireless device 228 is located within predefined space based on UWB location data 343, and authorize access to a protected function based on the location of the selected wireless device 228.

Each anchor device 104, 106, 108, 110, 112 includes a wireless communication interface for UWB RF communication and is configured to transmit and/or receive UWB RF signals 338, 339, 340, 341, 342 to and from the selected wireless device 228. Each anchor device 104, 106, 108, 110, 112 is further configured to generate and/or provide UWB location data 343, such as ToF or other ranging data, to the host processing system 102 via the bus 301. For example, the anchor device 104 may be configured to act as a central device for UWB localization including collecting the UWB location data 343 and providing it to the host processing system 102. The anchor devices 106, 108, 110, 112 may be configured to act as secondary anchor devices for UWB localization.

The bus 301 includes a wired communication medium, such as a controller area network (CAN) bus or other vehicle communication bus, for coupling the host processing system 102 to the anchor devices 104, 106, 108, 110, 112. In the depicted embodiment, the bus 301 is arranged to carry UWB location data 343 and other control information between the anchor devices 104, 106, 108, 110, 112 and the host processing system 102.

The selected wireless device 228 is depicted as a smartphone. The selected wireless device 228 includes a UWB communication interface for transmitting and/or receiving UWB RF signals 338, 339, 340, 341, 342 to and from the anchor devices 104, 106, 108, 110, 112. The selected wireless device 228 is configured to participate in a UWB localization protocol with the anchor devices 104, 106, 108, 110, 112, such that UWB location data 343 can be generated and provided to the host processing system 102.

The UWB RF signals 338, 339, 340, 341, 342 include UWB radio frequency signals exchanged between the selected wireless device 228 and each of the anchor devices 104, 106, 108, 110, 112. In the depicted embodiment, each UWB RF signal 338, 339, 340, 341, 342 is associated with a respective anchor device and is used for determining the location of the selected wireless device 228. The UWB RF signals 338, 339, 340, 341, 342 may include short duration pulses.

The UWB location data 343 includes data generated by the anchor devices 104, 106, 108, 110, 112 based on the UWB RF signals 338, 339, 340, 341, 342 exchanged with the selected wireless device 228. The UWB location data 343 is transmitted from the anchor devices 104, 106, 108, 110, 112 to the host processing system 102 via the bus 301. The UWB location data 343 is used by the host processing system 102 to perform UWB localization 344 of the selected wireless device 228. UWB localization 344 represents the localization of the selected wireless device 228.

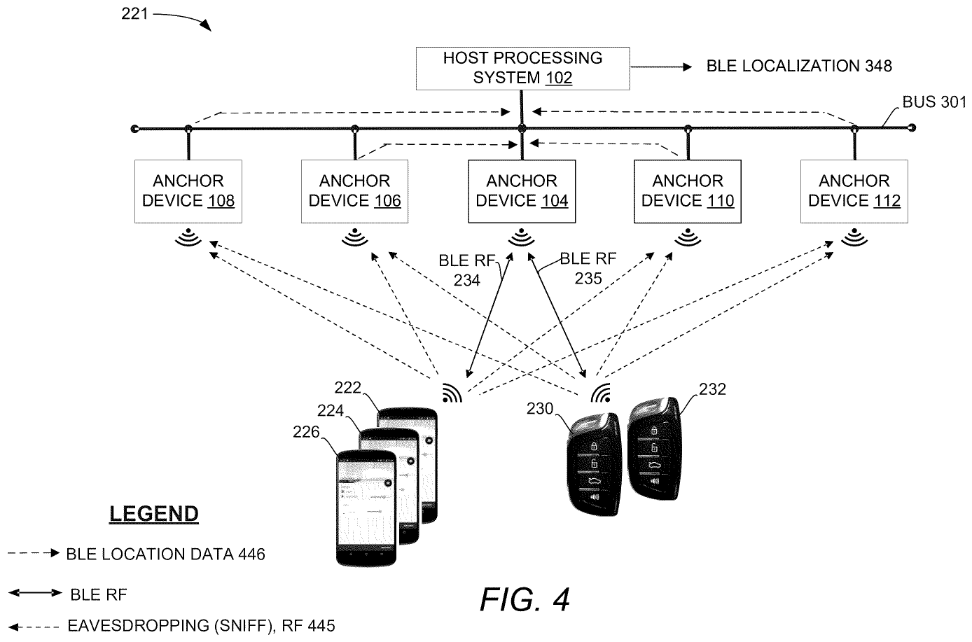

FIG. 4 is a block diagram illustrating Bluetooth Low Energy (BLE) localization, in accordance with embodiments. The access system 221 is shown to include the host processing system 102, the plurality of anchor devices 104, 106, 108, 110, 112, and the plurality of wireless devices 222, 224, 226, 230, 232, wherein the anchor devices 104, 106, 108, 110, 112 are communicatively coupled to each other and the host processing system 102 via a bus 301, and the wireless devices 222, 224, 226, 230, 232 are wirelessly coupled to the anchor devices 104, 106, 108, 110, 112. The host processing system 102, the anchor devices 104, 106, 108, 110, 112, the plurality of wireless devices 222, 224, 226, 230, 232, and the bus 301 may be capable of performing the functionality described with respect to at least FIG. 3 and at least the additional functionality described with respect FIG. 4.

The anchor device 104 may be configured to act as a central device for BLE communication with the wireless devices 222, 224, 226, 230, 232, including collecting the BLE location data 446 and providing it to the host processing system 102. The anchor devices 106, 108, 110, 112 may be configured to act as secondary anchor devices for BLE localization. The anchor devices 104, 106, 108, 110, 112 may be further configured to eavesdrop on BLE RF communications between the wireless devices 222, 224, 226, 230, 232 and use a result of the eavesdropping to generate BLE locations data. In alternative embodiments (not shown), another anchor device may act as the central and yet other anchor devices may perform eavesdropping.

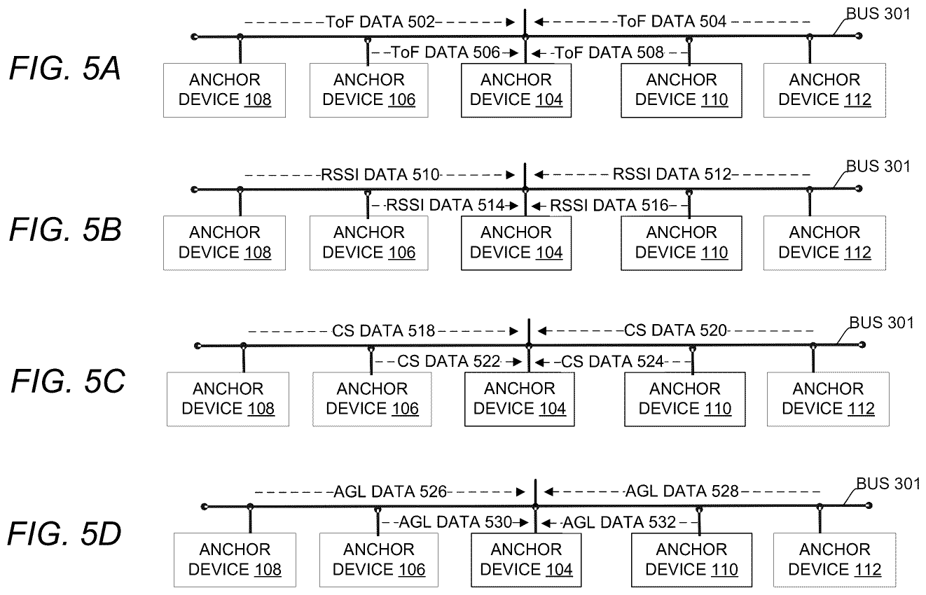

The wireless devices 222, 224, 226, 230, 232 are configured to communicate with the anchor device 104 via BLE RF links 234, 235, which may represent as many BLE connections are there are wireless devices. The wireless devices 222, 224, 226, 230, 232 are further configured to transmit RF signals that may be received by the anchor devices 104, 106, 108, 110, 112 for localization purposes. The BLE RF links 234, 235 include wireless communication links between the wireless devices 222, 224, 226, 230, 232 and the anchor device 104. The BLE RF links 234, 235 are used for communication and for localization of the wireless devices 222, 224, 226, 230, 232. The BLE location data 446 includes data used for localization of the wireless devices 222, 224, 226, 230, 232. As will be discussed with respect to FIGS. 5B-5D, the BLE location data 446 may include RSSI data, CS data, or AoA or AoD data.

The eavesdropped RF signals 445 include RF signals received by the anchor devices 106, 108, 110, 112 from the BLE RF communications between the wireless devices 222, 224, 226, 230, 232 and the anchor device 104. The eavesdropped RF signals 445 are used to generate BLE location data 446 for localization of the wireless devices 222, 224, 226, 230, 232. Eavesdropping as used herein may include, without limitation, intercepting RF transmissions of a wireless device.

BLE localization 348 indicates the localization of the wireless devices 222, 224, 226, 230, 232 using BLE location data 446. In embodiments, BLE localization 348 is performed by the host processing system 102 based on the BLE location data 446 received from the anchor devices 104, 106, 108, 110, 112.

The UWB localization of FIG. 3 and the BLE localization of FIG. 4 are designed to occur concurrently. This is because the inventors realized that by performing concurrent localization, the access system 221 provides reduced latency and power consumption access authorization compared to conventional systems that localize all devices serially using a single protocol. The inventors further realized that by using BLE location data 446 generated from eavesdropped RF signals 445, the access system 221 provides efficient and scalable localization of multiple wireless devices without requiring direct BLE connections between each anchor device and wireless device. Various types of location data are now discussed with respect to FIGS. 5A-5D.

FIGS. 5A, 5B, 5C, and 5D each schematically illustrate, in the form of block diagrams, the transfer of different types of location data between anchor devices 104, 106, 108, 110, 112 and the bus 301. The anchor devices 104, 106, 108, 110, 112 are configured to determine (e.g., based on received RF signals from wireless devices) and provide location data 502, 504, 506, 508 to the bus 301 for use in localization by a central anchor device or a host processing system. The dashed lines in each figure represent the flow of location data. FIG. 5A is a block diagram illustrating ToF data for UWB localization, in accordance with embodiments. In embodiments, the UWB location data may include or be based on channel impulse response data. FIG. 5B is a block diagram illustrating RSSI data for BLE localization, in accordance with embodiments. FIG. 5C is a block diagram illustrating CS data for BLE localization by a vehicle access system, in accordance with embodiments. In embodiments, CS data 518, 520, 522, 524 may be determined based on round trip time or phase-based ranging measurements of received RF signals. FIG. 5D is a block diagram illustrating AoA or AoD data for BLE localization, in accordance with embodiments. In FIG. 5D, each of angle (AGL) data 526, 528, 530, 532 may include AoA data or AoD data, determined based on measurements and/or demodulation of received RF signals.

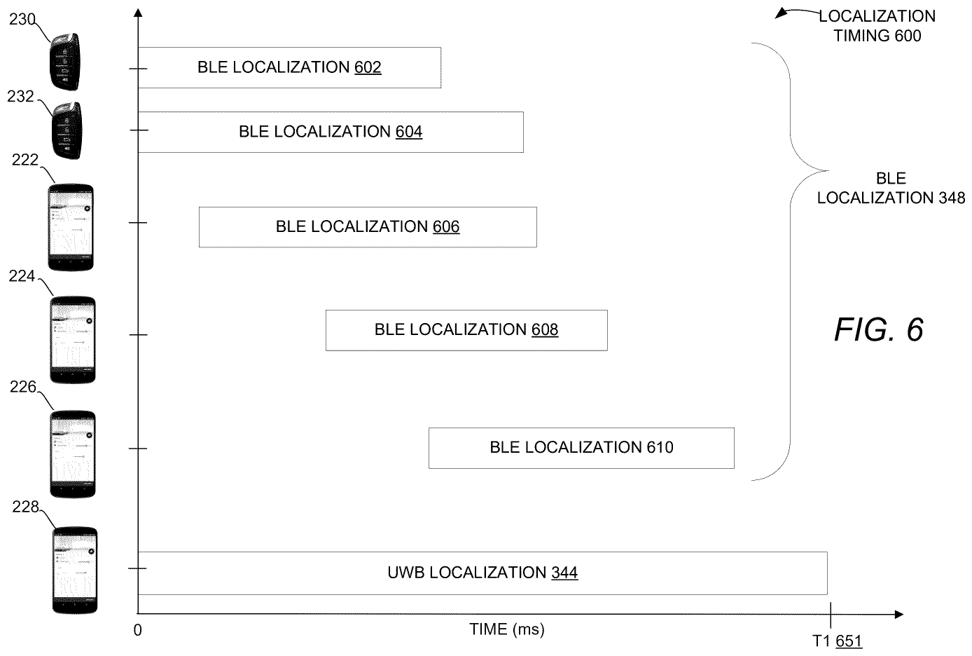

FIG. 6 is a timing diagram 600 illustrating timing of UWB localization 344 and BLE localization 348, in accordance with embodiments. FIG. 6 schematically illustrates the concurrent localization of a plurality of wireless devices 222, 224, 226, 228, 230, 232 using BLE localization 348 and UWB localization 344. The time axis TIME (ms) represents the elapsed time for localization operations. BLE localization 348 includes localization of wireless devices 222, 224, 226, 230, and 232 as indicated by BLE localization 606, BLE localization 608, BLE localization 610, BLE localization 602, and BLE localization 604, respectively. Each BLE localization is shown to start at time T=0 or later and end by T1 651. UWB localization 344 includes localization of the wireless device 228 and represents the time taken to localize the selected first wireless device 228. UWB localization is shown to start at time 0 and end at T1 651. In embodiments, BLE localization 348 includes anchor detection of the wireless devices 222, 224, 226, 230, and 232 based on RF signals; generation of location data by each anchor device; and localization of the wireless devices 222, 224, 226, 230, and 232 by an anchor device or a host processing system. In embodiments, UWB localization 344 includes anchor detection of the wireless device 228 based on RF signals; establishing a connection between the wireless device 228 and each anchor device; generation of location data by each anchor device based on RF signals; and localization of the wireless devices 228 by an anchor device or a host processing system. In other embodiments BLE localization or UWB localization may be defined to include greater or fewer operations relative to those just described, without departing from the claimed subject matter.

In FIG. 6, the BLE localization 348 of wireless devices 222, 224, 226, 230, and 232 is completed no later than the completion of UWB localization 344 of wireless device 228. In some embodiments, T1 651 is no greater than 96 milliseconds but the minimum period of time for localization may be greater than or less than 96 milliseconds, depending on system configuration and protocol timing. As shown by BLE localization 606, BLE localization 608, BLE localization 610, BLE localization 602, and BLE localization 604, embodiments may include multiple start and/or end times that represent different timing relationships, such as staggered or sequential localization periods. In further embodiments, without departing from the claimed subject matter, UWB localization 344 and BLE localization 348 may be concurrent, but may not be completed by T1 651.

The inventors have realized that concurrent localization of a selected first wireless device 228 using UWB localization 344 and other wireless devices 222, 224, 226, 230, 232 using BLE localization 348 around a defined period of time, as depicted in FIG. 6, provides reduced overall latency and power consumption for vehicle function authorization compared to conventional systems that localize all devices serially using a single protocol.

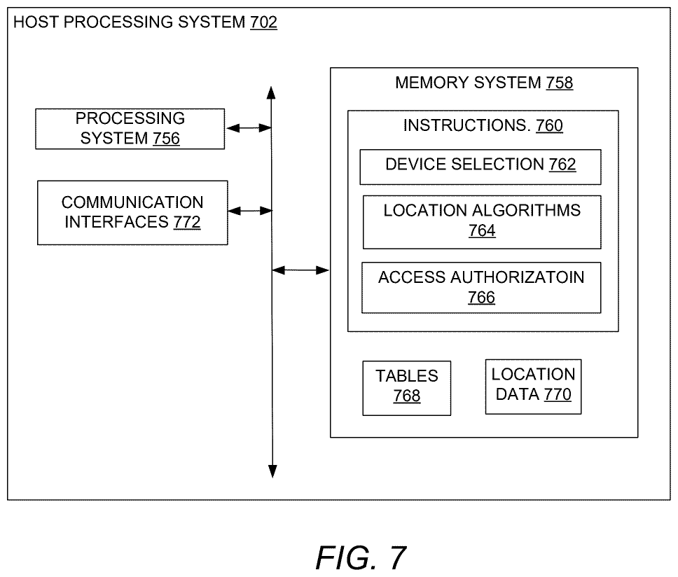

FIG. 7 is a block diagram illustrating a host processing system 702, in accordance with embodiments. The host processing system 702 includes a processing system 756, a memory system 758, and communication interfaces 772. The processing system 756 is configured to process instructions 760 stored in the memory system 758.

The processing system 756, the memory system 758, and the communication interfaces 772 are interconnected to enable the host processing system 702, operating in conjunction with anchor devices and wireless devices, to select a first wireless device, concurrently perform first and second localizations, and authorize access to a vehicle function based on the location of the selected first wireless device. In various embodiments, processing system 756 may include one or more processors and/or the host processing system 756 may include a distributed architecture in which the functions of device selection, localization, and access authorization are performed by separate processing units.

According to some embodiments, the memory system 758 may include one or more non-volatile memories, volatile memories, or a combination thereof. The instructions 760 include device selection 762, location algorithms 764, and access authorization 766. All or a portion of the logic underlying the various instructions 760 may be implemented in whole or in part dedicated hardware, without departing from the claimed subject matter. The device selection 762 is configured to select a first wireless device out of a plurality of wireless devices, the selection being based on one or more values stored in the memory system 758, such as in the tables 768. The location algorithms 764 are configured to perform first localization based on first location data associated with a first communication protocol, and to perform second localizations based on second location data associated with a second communication protocol. The access authorization 766 is configured to authorize access to a vehicle function based on the selected first wireless device being located within a predefined space, such as a vehicle cabin. In some embodiments, authorization requires device authentication and/or compliance with interoperability standards requiring the use of UWB location data for authorization of certain vehicle functions.

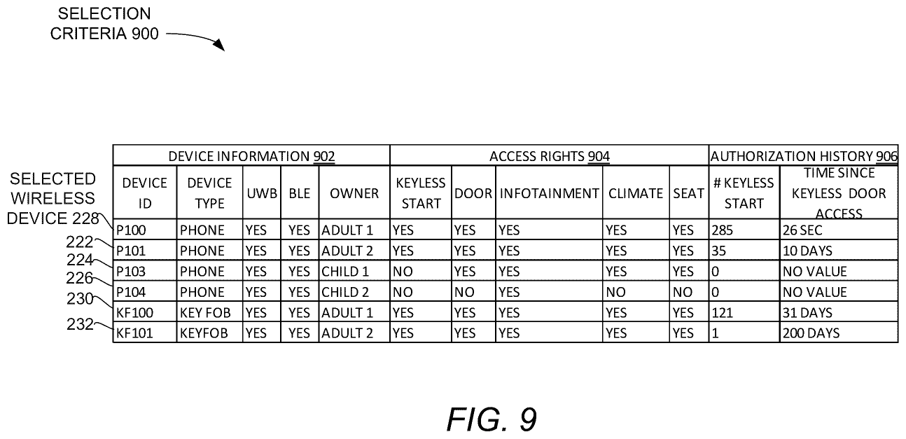

The memory system 758 further includes tables 768 and location data 770. As discussed with respect to FIG. 9, the tables 768 may include values such as access rights, authorization history, usage frequency, or other attributes associated with the wireless devices. The location data 770 includes first location data associated with a first communication protocol, such as UWB location data, and second location data associated with a second communication protocol, such as BLE location data. In alternative embodiments the memory system 758 may include additional or alternative modules, such as security modules, data logging modules, or modules for communication protocol management.

The communication interfaces 772 are configured to communicatively couple the host processing system 702 with one or more anchor devices, wireless devices, or other components of the access system. The communication interfaces 772 are configured to receive first location data and second location data via the anchor devices. The communication interfaces 772 may be configured for wired or wireless communication with anchor devices and wireless devices. In various embodiments, the communication interfaces 772 may include interfaces for additional communication protocols, such as Ethernet, CAN bus, LIN bus, Wi-Fi, BLE, or other automotive, wired, or wireless communication standards.

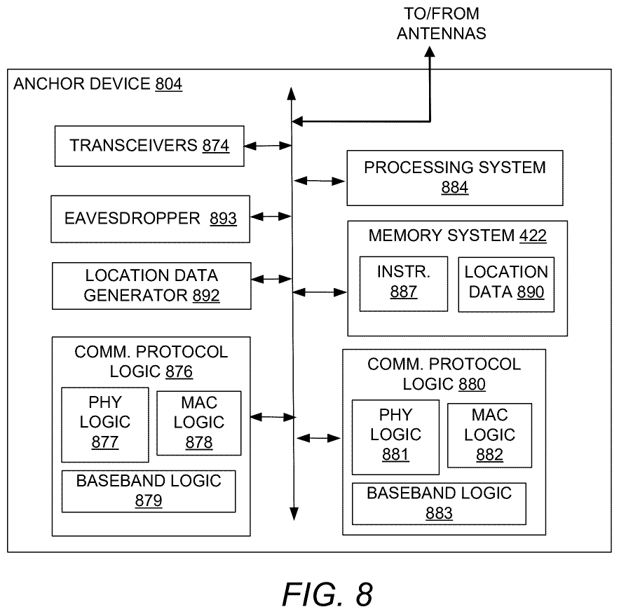

FIG. 8 is a block diagram illustrating an anchor device, in accordance with embodiments. In embodiments, the anchor device 804 is configured to receive RF signals from wireless devices, process protocol-specific signals, determine location data, and provide location data to the processing system 884. The anchor device 804 may provide location data to the host processing system 702 for localization and access authorization. The anchor device 804 may be configured as a central anchor device and/or a secondary anchor device.

The anchor device 804 is configured to interconnect the transceivers 874, location data generator 892, communication protocol logic 876, communication protocol logic 880, processing system 884, and memory system 422, via a data bus or interconnecting data lines. In the depicted embodiment, the data bus is configured to transfer data and control signals between the modules. The anchor device 804 may include alternative interconnection schemes, such as point-to-point links or networked interconnects. In addition, the anchor device 804 may be configured to operate in different physical form factors, such as integrated circuits, system-on-chip modules, or distributed hardware platforms.

The processing system 884 includes at least one processor configured to execute instructions for localization and access authorization. In the depicted embodiment, the processing system 884 is communicatively coupled to the memory system 422. In embodiments, the processing system 884 may includes multiple processors, microcontrollers, and/or digital signal processors.

The memory system 422 includes a non-transitory memory medium configured to store instructions and data. In the depicted embodiment, the memory system 422 includes instructions 887 and a location data 890. The instructions 887 includes instructions executable by the processing system 884 to support localization (e.g., location data generation) and/or access authorization (e.g., identifying access-related information about wireless devices). The location data 890 includes data determined by the anchor device 804 representing or used to calculate the location of wireless devices. In embodiments, the memory system 442 may include instructions and data that are the same or similar to the instructions 760, tables 768, and location data 770 described with respect to FIG. 7, and the processing system 884 may be configured to perform some or all of the localization and access authorization functions described with respect to the host processing system 702 of FIG. 7.

The anchor device 804 is configured to communicate with one or more antennas (e.g., antenna arrays) for transmission and reception of RF signals. The transceivers 874 includes circuitry configured to transmit and receive RF signals associated with communication protocols. For example, the transceivers 874 may include a transceiver configured to operate with UWB and a transceiver configure to operate with BLE protocols. The transceivers 874 may alternatively or additionally include circuitry configured to operate with other wireless communication protocols, such as Wi-Fi, Zigbee, and/or proprietary RF protocols.

The communication protocol logic 876 includes logic configured to implement protocol-specific operations (e.g., UWB and/or BLE protocol) for wireless communication. In the depicted embodiment, the communication protocol logic 876 includes a PHY logic 877, a MAC logic 878, and a baseband logic 879. The PHY logic 877 includes circuitry and logic configured to implement physical layer operations for communication protocols. The MAC logic 878 includes circuitry and logic configured to implement medium access control layer operations. The baseband logic 879 includes circuitry and logic configured to implement baseband signal processing. In some embodiments, the communication protocol logic 876 includes logic for other communication protocols such as Wi-Fi or Zigbee, and/or proprietary RF protocols. The communication protocol logic 880 may be the same or similar to the protocol logic 876. In embodiments, when communication protocol logic 876 supports BLE protocol but not UWB protocol, communication protocol logic 880 is configured to at least support UWB protocol.

Eavesdropper 893 is to eavesdrop or sniff RF transmissions such as packets communicated between other wireless devices, using techniques known by one having ordinary skill in the art or proprietary techniques. Eavesdropper 893 may also have the capability to analyze RF transmissions. Eavesdropper 893 may be implemented in whole or in part by transceivers 874, processing system 884, communication protocol logic 876, 880, and/or dedicated circuitry. In embodiments, eavesdropper may extract relevant information from RF transmissions to be used by location data generator 892. In various embodiments, Eavesdropper 893 may be configured to eavesdrop on wireless communications, such as BLE, Zigbee, Wi-Fi or UWB.

Location data generator 892 is to generate location data used for UWB and BLE localization or other protocol-based localizations using techniques known by one having ordinary skill in the art or proprietary techniques. For example, location data generator 892 may use circuitry and logic configured to derive or calculate, based on RF signals received by the transceivers 874, RSSI data, ToF data, CS data, or AoA or AoD data. Location data generator 892 may be implemented in whole or in part by transceivers 874, processing system 884, communication protocol logic 876, 880, and/or dedicated circuitry.

FIG. 9 is a table diagram illustrating a selection criteria 900, in accordance with embodiments. In an embodiment, the selection criteria 900 are used to select of a first wireless device 228 out of a plurality of wireless devices 222, 224, 226, 230, 232.

Each row of the table corresponds to a wireless device, 222, 224, 226, 228, 230, 232. The example selection criteria 900 include device information 902, access rights 904, and authorization history 906. The device information 902 includes a device ID column, a device type column, a UWB column, a BLE column, and an owner column. The access rights 904 include a keyless start column, a door column, an infotainment column, a climate column, and a seat column. The authorization history 906 includes a number of keyless starts column and a time since keyless door access column.

The device ID column includes identifiers for each wireless device, such as P100, P101, P103, P104, KF100, and KF101. The device type column includes the type of each wireless device, such as PHONE or KEY FOB. The UWB column includes an indication of whether the wireless device supports UWB localization. The BLE column includes an indication of whether the wireless device supports BLE localization. The owner column includes an indication of the owner of the wireless device, such as ADULT 1, ADULT 2, or CHILD 1, CHILD 2. The keyless start column includes an indication of whether the wireless device has access rights for keyless start. The door column includes an indication of whether the wireless device has access rights for door access. The infotainment column includes an indication of whether the wireless device has access rights for infotainment functions. The climate column includes an indication of whether the wireless device has access rights for climate control functions. The seat column includes an indication of whether the wireless device has access rights for seat adjustment functions. The number of keyless starts column includes a value indicating the number of times the wireless device was authorized for keyless start. The time since keyless door access column includes a value indicating the time since the wireless device was authorized for keyless door access.

In the depicted embodiment, the selected wireless device 228 is P100, which is a PHONE owned by ADULT 1, supports both UWB and BLE localization, has access rights for keyless start, door, infotainment, climate, and seat functions, has been authorized for keyless start 285 times, and was last authorized for keyless door access 26 seconds ago. In the depicted embodiment, the other wireless devices 222, 224, 226, 230, 232 include a mix of PHONE and KEY FOB devices, with varying access rights and authorization histories.

Selection may be based on a wireless device meeting one or more selection criteria 900. For example and not limitation: the selection may include determining that the first wireless device 228 has access rights to the first protected resource, such as keyless start, the selection may include determining that the first wireless device 228 is more frequently authorized to access the first protected resource relative to the plurality of second wireless devices 222, 224, 226, 230, 232, the selection may include determining that the first wireless device 228 was authorized to open a door of the vehicle, and/or the selection may include determining that the first wireless device 228 is a PHONE, and at least one second wireless device 230 is a KEY FOB.

The device information 902, access rights 904, and authorization history 906 may be stored in the memory system 758 of the host processing system 702. The host processing system 702 may update such data and information after a change in the data or information. The update may be triggered by the change or may be made at set intervals. As described with respect to FIG. 7, the host processing system 702 may process instructions stored in the memory system 758 to select the first wireless device 228 based on the stored values, perform localization of the selected first wireless device 228 using UWB location data, perform localization of the plurality of second wireless devices 222, 224, 226, 230, 232 using BLE location data, and authorize access to one or more vehicle functions based on the location and access rights of the wireless devices.

According to various embodiments (not shown), the device information 902 may include additional columns, such as device model, battery status, or firmware version; the access rights 904 may include additional columns, such as trunk access or window control; and the authorization history 906 may include additional columns, such as time since last infotainment access or number of climate control authorizations. In some embodiments (not shown), the selection criteria 900 may include a weighted combination of multiple factors, such as access rights, usage frequency, recency, device type, and owner.

The inventors have realized that by storing device information 902, access rights 904, and authorization history 906 in a memory system 758, and applying selection criteria 900 to select a first wireless device 228 for UWB localization, the system can reduce latency and power consumption for vehicle access authorization, while supporting flexible and protocol-specific security policies and efficient personalization of vehicle functions.

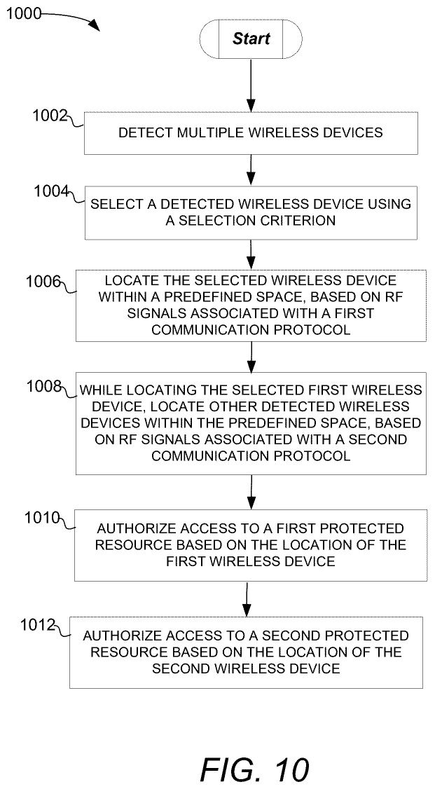

FIG. 10 is a flow diagram illustrating a method of authorizing access to protected resources, in accordance with embodiments. The method may performed using hardware, software, or a combination of hardware and software.

The detect multiple wireless devices block 1002 includes detecting a plurality of wireless devices, such as key fobs, smartphones, or wearable devices, that are present within or proximate to a predefined space, such as a vehicle cabin. The detection may be performed by a host processing system or the one or more anchor devices communicatively coupled to the host processing system. According to some embodiments, the detection includes receiving wireless signals, such as BLE advertising packets, connection requests, or signals that indicate connection status from the wireless devices. According to alternative embodiments, the detection may include an anchor device polling for wireless devices using a scanning procedure or receiving device presence information from a networked system.

The select a wireless device using a selection criterion block 1004 includes selecting a first wireless device from among the detected wireless devices based on one or more selection criteria. In an embodiment, the wireless device must be granted at least the access rights to a protected resource (e.g., keyless start) selection criterion to be selected.

The locate the selected wireless device within a predefined space, based on RF signals associated with a first communication protocol block 1006 includes localizing the selected first wireless device using a first communication protocol, such as UWB. The localization includes determining a position of the selected wireless device within the vehicle cabin using UWB location data or based on other high-accuracy RF protocols or proprietary ranging techniques.

The while locating the selected first wireless device, locate other detected wireless devices within the predefined space, based on RF signals associated with a second communication protocol block 1008 includes concurrently localizing the remaining detected wireless devices using a second communication protocol, such as BLE. In the depicted embodiment, the localization includes determining the position of the other wireless devices using BLE location data, such as RSSI, CS, angle of AoA or AoD of departure data or a combination of BLE localization techniques or using other low power protocols for localization. According to some embodiments, the BLE localization includes eavesdropping on BLE communications between the wireless devices and a central anchor device, with anchor devices forwarding RSSI or other location data to the host processing system. According to alternative embodiments, the BLE localization may include using active BLE connections.

The authorize access to a first protected resource based on the location of the first wireless device block 1010 includes authorizing access to a protected resource, such as keyless start, based on the determined location of the selected first wireless device. The authorization may be performed if the selected first wireless device is located within the vehicle cabin, as determined by UWB localization and other authorization requirements are met. According to some embodiments, the authorization is contingent on meeting a security requirement, such as compliance with an interoperability standard requiring UWB-based localization for keyless start. The authorization may also be based on additional criteria, such as device authentication or user confirmation.

The authorize access to a second protected resource based on the location of the second wireless device block 1012 includes authorizing access to a second protected resource, such as an infotainment system function, seat adjustment function, or climate control function, based on the location of a second wireless device. The authorization may be performed if the second wireless device is located within the vehicle cabin, as determined by BLE localization and any other authorization requirements are met. According to some embodiments, the access authorization includes enabling personalization features for multiple users based on the location of their respective wireless devices. The access authorization may also include granting access to additional vehicle functions or services based on the location, type of the wireless device and/or owner of the wireless device.

In embodiments, the method 1000 may include additional process steps (not shown), such as updating access rights, updating authorization history, or dynamically adjusting selection criteria based on user preferences or system policies. According to some embodiments, the method 1000 is performed by a processing system comprising at least one processor and a memory system, with instructions stored in the memory system for executing the process steps. The method 1000 may also be performed by a distributed system comprising multiple anchor devices and wireless devices, with selection, localization and authorization functions distributed among the system components.

The above description is intended to be illustrative, and not restrictive. For example, the above-described embodiments (or one or more aspects thereof) may be used in combination with each other. Other embodiments will be apparent to those of skill in the art upon reviewing the above description. In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. In the event of inconsistent usages between this document and those documents so incorporated by reference, the usage in the incorporated reference(s) should be considered supplementary to that of this document; for irreconcilable inconsistencies, the usage in this document supersedes the usage in any incorporated references.

Although the claimed subject matter has been described with reference to specific embodiments, it will be evident that various modifications and changes may be made to these embodiments without departing from the broader spirit and scope of what is claimed. Accordingly, the specification and drawings are to be regarded in an illustrative rather than a restrictive sense. The scope of the claims should be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended; a system, device, article, or process that includes elements in addition to those listed after such a term in a claim are still deemed to fall within the scope of that claim. Moreover, in the following claims, the terms “first,” “second,” and “third,” etc. are used merely as labels and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims.

What is claimed is:

1. A method comprising:
selecting a first wireless device based on at least one selection criterion;
locating the selected first wireless device within a predefined space, based on radio frequency (RF) signals associated with a first communication protocol;
while locating the selected first wireless device, locating a plurality of second wireless devices within the predefined space, based on RF signals associated with a second communication protocol; and
authorizing access to a first protected resource based on the location of the first wireless device.

2. The method of claim 1, wherein authorizing access to the first protected resource includes meeting a security requirement, the security requirement including locating the selected first wireless based on RF signals associated with the first communication protocol.

3. The method of claim 1, wherein locating the plurality of second wireless devices while locating the selected first wireless device comprises completing the locating of the plurality of second wireless devices no later than completing the locating of the selected first wireless device.

4. The method of claim 1, wherein the locating of the plurality of second wireless devices based on RF signals associated with the second communication protocol comprises locating at least one second wireless device, of the plurality of second wireless devices, based on RF signals eavesdropped from a communication of the at least one second wireless device.

5. The method of claim 1, wherein the locating of the first wireless device within the predefined space, based on RF signals associated with the first communication protocol comprises using Ultra-wideband (UWB) location data associated with a UWB protocol.

6. The method of claim 5, wherein the using of the UWB location data comprises using time of flight data.

7. The method of claim 1, wherein the locating of the plurality of second wireless devices within the predefined space, based on RF signals associated with the second communication protocol comprises using Bluetooth Low Energy (BLE) location data associated with a BLE protocol.

8. The method of claim 7, wherein the using of the BLE location data comprises using Received Signal Strength Indicator (RSSI) data, channel sounding data, angle of arrival data, or angle of departure data.

9. The method of claim 1, wherein selecting the first wireless device based on the at least one selection criterion comprises determining that the first wireless device has access rights to the first protected resource.

10. The method of claim 1, wherein selecting the first wireless device based on the at least one selection criterion comprises determining that the first wireless device is more frequently authorized to access the first protected resource relative to the plurality of second wireless devices.

11. The method of claim 1, wherein locating the first wireless device and the plurality of second wireless devices within the predefined space comprises locating the first wireless device and the second wireless device within a vehicle cabin of a vehicle.

12. The method of claim 11, wherein selecting the first wireless device based on the at least one selection criterion comprises determining that the first wireless device was authorized to open a door of the vehicle.

13. The method of claim 11, wherein selecting the first wireless device is based on the at least one selection criterion comprises determining that at least one second wireless device, of the plurality of second wireless devices, is a key fob, determining that the first wireless device is a phone, and selecting the first wireless device based on determining that the first wireless device is the phone.

14. A processing system, comprising:
a least one processor; and
a memory system, the at least one processor configured to process instructions stored in the memory system to:
select a first wireless device out of a plurality of wireless devices, the selection based on one or more values stored in the memory system,
based on Ultra-wideband (UWB) location data associated with a UWB protocol, perform first localization to determine that the selected first wireless device is located within a vehicle cabin,
concurrent with the performance of the first localization, perform second localizations based on Bluetooth Low Energy (BLE) location data associated with a BLE protocol, to locate second wireless devices of the plurality of wireless devices within the vehicle cabin,
authorize access to a first vehicle function based on the selected first device being located within the vehicle cabin; and
authorize access to a second vehicle function based on a first second wireless device being located within the vehicle cabin.

15. The processing system of claim 14, wherein the at least one processor is configured to complete the second localizations no later than a time that the at least one processor completes the first localization.

16. The processing system of claim 14, wherein the BLE location data comprises one or more of Received Signal Strength Indicator (RSSI) data, Channel Sounding (CS) data, or Angle of Arrival (AoA) or Angle of Departure (AoD) data.

17. The processing system of claim 14, wherein at least a portion of the BLE location data is based on eavesdropped BLE RF signals of a BLE connection between a first second wireless device and an anchor device.

18. The processing system of claim 14, wherein the one or more values stored in the memory system indicate that the first wireless device is associated with access rights to the first vehicle function, wherein the first vehicle function is keyless start

19. A system, comprising:
a processing system;
a first anchor device communicatively coupled with the processing system, the first anchor device configured to wireless communicate with a plurality of wireless devices; and
a plurality of second anchor devices communicatively coupled with the first anchor device, each second anchor device configured to provide a portion of first location data associated with a first communication protocol and a portion of second location data associated with a second communication protocol, the processing system configured to:
select a first wireless device, of the plurality of wireless devices;
within a period of time, locate the selected first wireless device based on the portions of first location data;
within the period of time, locate at least two second wireless devices of the plurality of wireless devices, based on the portions of second location data; and
authorize access to a first vehicle function based on the selected first device being located within a vehicle cabin.

20. The system of claim 19, wherein each of the plurality of second anchor devices is configured to eavesdrop on communications between the plurality of wireless devices and the first anchor device to provide the portion of second location data.
